(19) United States
(12) Patent Application Publication
(10) Pub. No.: US 2024/0375322 A1
(43) Pub. Date: Nov. 14, 2024

(54) METHOD OF RECYCLING USED PRINTING PLATES

(71) Applicant: MacDermid Graphics Solutions, LLC, Waterbury, CT (US)

(72) Inventor: Ryan W. Vest, Mequon, WI (US)

(21) Appl. No.: 18/583,998

(22) Filed: Feb. 22, 2024

Related U.S. Application Data
(60) Provisional application No. 63/465,100, filed on May 9, 2023.

(51) Int. Cl. B29B 17/04; B29B 17/00; B29B 17/02; B29K 75/00; B29K 105/26; B29L 31/00

(52) U.S. Cl. CPC B29B 17/0412; B29B 17/02; B29B 2017/001; B29B 2017/0224; B29K 2075/00; B29K 2105/26; B29L 2031/767

(57) ABSTRACT

A method of producing a granulated product from photopolymer printing plate materials. The method includes the steps of (a) sorting the photopolymer printing plate materials based on an identifiable property, wherein the photopolymer printing plate materials comprise one or more photopolymer layers; (b) subjecting the photopolymer printing plate materials to UV-C light from a UV-C light source for a period of time, whereby the photopolymer printing plate materials are rendered less tacky and more brittle; (c) grinding the photopolymer printing plate materials to particles; and (d) screening the particles to remove particles above a certain size and create the granulated product.

### FIELD OF THE INVENTION

The present invention relates generally to a method of recycling flexographic printing elements.

### BACKGROUND OF THE INVENTION

Flexographic printing elements are typically relief plates with image elements raised above open areas. Such plates offer a number of advantages to the printer, based chiefly on their durability and the case with which they can be made. Flexographic printing elements can be used for large volume printing jobs on various substrates, including films, foils, papers, corrugated board, paperboard, etc. and at high print speeds.

A typical flexographic printing blank as delivered by its manufacturer, is a multilayered article that typically includes, in order, a backing or support layer, one or more unexposed photocurable layers, a protective layer or slip film, and a cover sheet. The processed flexographic relief image printing element comprises a relief image on the surface of the printing element.

This relief image can be created by various methods. For example, the flexographic printing element may be produced by imaging the photocurable printing blank to produce a relief image on the surface of the printing element. This is generally accomplished by selectively exposing the photocurable material to actinic radiation through a mask or negative, which exposure acts to harden or crosslink the photocurable material in the irradiated areas. Alternatively, the relief image can be formed by selectively laser engraving photocured, photopolymerized, or vulcanized layers to produce the desired relief image. Other methods of creating the relief image are also known to those skilled in the art. The photocurable printing blank can be in the form of a continuous (seamless) sleeve or as a flat, planar plate that is mounted on a carrier.

The printing element may be selectively exposed to actinic radiation in various ways. For example, a photographic negative with transparent areas and substantially opaque areas is used to selectively block the transmission of actinic radiation to the printing plate element. Alternatively, an in situ negative is created by selectively laser ablating an actinic radiation (substantially) opaque layer on top of the one or more photopolymer layers that is sensitive to laser ablation. In still another alternative, a focused beam of actinic radiation is used to selectively expose the photopolymer. Any of these alternative methods is acceptable, with the criteria being the ability to selectively expose the photopolymer to actinic radiation thereby selectively curing portions of the photopolymer.

Liquid photopolymers may also be used to construct flexographic printing elements and the liquid photopolymer is selectively crosslinked and cured to create the desired relief image. The use of a liquid photopolymer in a liquid platemaking process involves a casting and exposure step in which a photographic negative is placed on a bottom glass platen and a cover film is placed over the negative in an exposure unit. The exposure unit generally comprises the bottom glass platen with a source of UV light below it (lower light) and a lid having flat top glass platen with a source of UV light above it (upper light). Liquid photopolymer not exposed to the lower light source (i.e., the uncured photopolymer) remains in a liquid state and can be reclaimed and reused. Various processes have been developed for producing printing plates from liquid photopolymer resins as described, for example, in U.S. Pat. No. 5,213,949 to Kojima et al., U.S. Pat. No. 5,813,342 to Strong et al., U.S. Pat. Pub. No. 2008/0107908 to Long et al., U.S. Pat. Pub. No. 2020/0207142 to Vest et al., and U.S. Pat. No. 3,597,080 to Gush, the subject matter of each of which is herein incorporated by reference in its entirety.

Thereafter, the photopolymer layer of the printing clement is developed to remove uncured (i.e., non-crosslinked) portions of the photopolymer, without disturbing the cured portions of the photopolymer layer, to produce the relief image. The development step can be accomplished in a variety of ways, including water washing, solvent washing, and thermal development (blotting).

Photopolymers used in flexographic printing elements generally contain one or more binders, monomers, plasticizers and photoinitiators, along with other performance additives. Preferred binders, especially for sheet polymers, include polystyrene-isoprene-styrene, and polystyrene-butadiene-styrene, especially block co-polymers of the foregoing. Examples of photopolymer compositions for sheet polymers include those described in U.S. Patent Application Publication No. 2004/0146806 to Roberts et al., the teachings of which are incorporated herein by reference in their entirety. Printing plates made from processing liquid photopolymers and laser engravable printing elements may contain different combinations of binders, monomers, plasticizers, photoinitiators, and other additives to produce a desired result. For example, printing plates produced from liquid photopolymers or photoresins may be based on ethylenically unsaturated prepolymers including, for example, unsaturated polyester resins, unsaturated polyurethane resins, unsaturated polyamide resins and unsaturated poly (meth) acrylate resins, such as, for example polyether urethane polymers, or polyether polyester urethane copolymers such as polyether polyester urethane methacrylate photopolymers.

Once the relief image printing clement has been prepared by any of the methods described above and/or as known in the art, the flexographic printing element can be attached to a printing cylinder and printing commenced.

Once a printing run is complete (or if a printing plate becomes worn out due to use), the printing plate must be discarded. Printing plate waste is a significant problem in the industry and companies are increasingly looking for more sustainable materials along with improved processes for recycling used materials without resorting to incineration or landfilling. In addition, unused photopolymer materials, including unexposed material that is left over from the manufacture of photopolymerizable printing plate blanks, including, for example, edge strips, losses from starting and stopping production, and unusable out-of-date raw printing plates also constitute waste, and it would be desirable to recycle these materials as well.

Therefore, it is an object of the present invention to develop an improved process for recycling and/or reusing and/or repurposing photopolymer relief image printing plates and unused photopolymer materials that must otherwise be discarded.

It is a recognized problem that cross-linked, hardened, or vulcanized materials cannot easily be readily reprocessed, reformed, re-used or recycled to their original compositions and uses. Crosslinking of elastomeric photopolymer compositions requires complex material formulations which can cause manufacturing complexities and difficulties, including premature set-up, incomplete cure, and short composition pot-life (i.e., premature crosslinking), especially when forming relatively thick flexographic printing plate precursors. In addition, even if the elastomeric photopolymer compositions can be recycled, it is generally necessary that at least the backing layers must be stripped from the photopolymer composition prior to further processing as it typically not possible to recycle the printing plate in its entirety without separation. In addition, it may also be necessary to be sure that the photocured materials that are processed are at least relatively similar to each other as dissimilar materials may require different recycling needs, requiring further separation and segregation to provide a recycled product in a reproducible manner and that is suitable for reuse.

As described above, flexographic printing plates generally consist of a backing layer, along with one or more layers of photocured material and these layers of photocured material may be the same or different from each other. Other layers include, for example, compressible layers, oxygen barrier layers, adhesive layers, capping layers, and antihalation layers, among others. Thus, flexographic printing plates typically comprise both thermoset and thermoplastic materials and it widely believed that such materials must be separated from each other (and thus processed separately) because the materials are incompatible with each other and the resulting product would not have desirable properties for further processing.

As compared to the starting chemistry of styrene/diene copolymers systems prior to any processing, the thermoset crosslinked materials differ significantly in the following ways:
a. Crosslinking renders the material insoluble, resulting in significant behavioral differences in physical properties, such as solvent and swell resistance, and utilization, such as mechanical or dispersive mechanisms for mixing (i.e., dissolution is not an option).
b. Thermal stability—the crosslinked material is thermoset and will not flow with heat.
c. The presence of the additional materials (i.e., oils, stabilizers, etc.) impacts properties such as light resistance in ways different than the starting unreacted products. In some cases, the materials are linked into the matrix already.
d. Orientation/phrasing is locked since the chains are tied together, which is one of the most critical differences between crosslinked and uncrosslinked SBC-based materials.

As a result of the crosslinked factuality resulting from exposure to actinic radiation, used printing plates are a significant chemical departure from the original styrene/butadiene or styrene/isoprene chemistries. This is a significant part of the difficulty in finding applications for used printing plate materials.

Additionally, for many years, one of the major difficulties in recycling elastomeric photopolymer printing elements has centered around the “sandwich” that exists with the presence of the elastomeric plate material in addition to the polyester backing, plus the presence of print by-product such as dried ink. In addition, recycling unexposed and exposed photopolymers tends to be difficult because photopolymer flexographic printing plates are synthetic resin composites. Traditionally, before such photopolymers can be recycled, the bonding of the individual synthetic resins must first be dissolved. Based thereon, there remains a significant market need to develop a process in which the used printing plates, including photocured materials and uncured photocurable materials, backing layers, cover layers, oxygen barrier layers, adhesive layers, capping layers, antihalation layers, print by-products, etc. can be repurposed in a simple and cost effective manner and that overcomes the deficiencies of the prior art.

U.S. Pat. No. 5,552,261 to Kraska et al., the subject matter of which is herein incorporated by reference in its entirety, describes a process for recycling exposed and/or unexposed photopolymer flexographic printing plates containing a photopolymerizable recording layer and a support. However, this method requires that the recording layer first be separated from the support layer and other such layers.

U.S. Pat. No. 8,920,692 to Landry-Coltrain et al., the subject matter of which is herein incorporated by reference in its entirety, describes a method of recycling used and unused laser engravable flexographic printing plate precursors and laser engraved flexographic printing elements. However, this method also requires that the laser engravable or laser engraved layer first be physically separated from the support layer and any other layers. In addition, as part of the described recycling process, the method also requires a step of melting of the laser engravable or laser engraved layer.

DE4026786A2 describes a method for recycling shredded old part and waste from fiber-reinforced, crosslinked duroplastic plastics. However, these materials are thermoset materials.

U.S. Pat. Pub. No. 2022/0235551 to Vest, the subject matter of which is herein incorporated by reference in its entirety, describes a method of recycling used printing plates to produce a granulated product that does not require separation of the layers prior to processing. However, it has been determined that certain materials, including plates made from liquid photopolymers and/or liquid processed printing plates, cannot be easily processed because of the increased levels of tackiness of these materials. Thus, there remains a need in the art for a recycling process that can produce a good result over a wider range of materials, including printing plates made from liquid photopolymers and other more tacky materials.

### SUMMARY OF THE INVENTION

It is an object of the present invention to provide a method of recycling flexographic printing plate precursor materials.

It is another object of the present invention to provide a method of recycling used flexographic relief image printing elements, including used printing plates and used printing sleeves containing both thermoset and thermoplastic components.

It is still another object of the present invention provide a method of recycling flexographic printing elements and materials that does not require that backing layers, substrates layers, compressible layers, and/or other dissimilar intermediate layers be removed during processing.

It is still another object of the present invention to provide a recycling method that allows the entire flexographic printing plate structure to be recycled in a simple and cost effective manner.

To that end, in one embodiment, the present invention relates generally to a method of producing a granulated product from photopolymer printing plate materials, the method comprising the steps of:
a) sorting the photopolymer printing plate materials based on an identifiable property;
b) optionally, shredding or chipping the photopolymer printing plate materials to reduce the size of the photopolymer printing plate materials to smaller chips or shreds having a relatively uniform size;
c) subjecting the photopolymer printing plate materials to UV-C light from a UV-C light source for a period of time, whereby the photopolymer printing plate materials are rendered less tacky and more brittle;
d) grinding the photopolymer printing plate materials to particles; and
e) screening the particles to remove particles above a certain size to produce the granulated product.

### DETAILED DESCRIPTION OF THE PREFERRED EMBODIMENTS

As described herein, in one embodiment, the present invention relates generally to a method of recycling photopolymer printing plate materials in a simple, cost effective manner to produce a granulated product and without the need to separate layers prior to processing. The resulting granulated product can be incorporated into various products alone or in combination with other post-consumer recycled materials.

It should be understood that the disclosed embodiments are merely illustrative of the present disclosure, which may be embodied in various forms. Therefore, details disclosed herein with reference to exemplary assemblies/fabrication methods and associated processes/techniques of assembly and use are not to be interpreted as limiting, but merely as the basis for teaching one skilled in the art how to make and use the advantageous assemblies/systems of the present disclosure.

As used herein, “a,” “an,” and “the” refer to both singular and plural referents unless the context clearly dictates otherwise.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the invention described herein. Furthermore, it is also to be understood that the value to which the modifier “about” refers is itself specifically disclosed herein.

As used herein, spatially relative terms, such as “beneath,” “below,” “lower,” “above,” “upper,” “front,” “back,” and the like, are used for case of description to describe one element or feature's relationship to another element(s) or feature(s). It is further understood that the terms “front” and “back” are not intended to be limiting and are intended to be interchangeable where appropriate.

As used herein, the terms “comprise(s)” and/or “comprising,” specify the presence of stated features, integers, steps, operations, elements, and/or components, but do not preclude the presence or addition of one or more other features, integers, steps, operations, elements, components, and/or groups thereof.

The inventors of the present invention have determined that various elastomeric photopolymers used in printing plates, including flexographic relief image printing plates containing ink residue, along with one or more layers of photopolymer, a backing layer, and other such layers may be processed to produce a granulated product that can be used in place of or in addition to other consumer recycled materials in various products. One of the major advantages of the process of the present invention is that it is not necessary to separate out any of the layers of the printing plate and the entire photocured printing element, including ink residues, cured photopolymer layer(s), backing layers, and any intermediate layers can be subjected to the steps described herein to produce the granulated product.

To that end, in one embodiment, the present invention relates generally to a method of producing a granulated product from photopolymer printing plate materials, the method comprising the steps of:
a) sorting the photopolymer printing plate materials based on an identifiable property, wherein the photopolymer printing plate materials comprise one or more photopolymer layers;
b) optionally, shredding or chipping the photopolymer printing plate materials to reduce the size of the photopolymer printing plate materials to smaller chips or shreds having a relatively uniform size;
c) subjecting the photopolymer printing plate materials to UV-C light from a UV-C light source for a period of time, whereby the photopolymer printing plate materials are rendered less tacky and more brittle;
d) grinding the photopolymer printing plate materials to produce particles or granules; and
e) screening the particles or granules to remove particles or granules above a certain size.

In one embodiment, the photopolymer printing plate materials comprise one or more of types of unused photocurable and/or photosensitive printing blanks and/or used photocured and/or photopolymerized printing elements.

In one preferred embodiment, the photopolymer printing plate materials comprise used photocured and/or photopolymerized printing elements as the inventors have found that these materials are more easily ground to produce the granulated product. In addition, the inventors have found that uncured printing plate materials are more hazardous and can cause irritation to workers who are handling the product.

As described herein, one of the steps of the instant invention involves identifying certain properties of the printing plate materials so that the materials can be sorted or screened by based on such identifiable properties. This allows the granulated product to be both consistent and reproducible. In one embodiment, the materials can be sorted based on the type of binder, melting point of the photopolymer materials, Shore A hardness of the photopolymer material, or other identifiable property. What is important is that the materials be sorted so that the resulting product has identifiable and consistent properties that are suitable for use in a particular end user product. This also allows one to identify materials that do not have any undesirable layers that are not recyclable.

In one embodiment, the inventors of the present invention have found that photopolymer printing plate materials based on styrenic block copolymer systems produce a good result. In one preferred embodiment, the photopolymer printing plate materials are based on a styrene-butadiene-styrene (SBS)-type photopolymer. In another embodiment, the photopolymer printing plate materials are based on a styrene-isoprene-styrene (SIS)-type photopolymer. While other types of photopolymers are known and would be usable in the practice of the instant invention, the inventors of the present invention have found that SBS-type photopolymer materials have greater stability and thus produce a consistent granulated product. Thus, in one embodiment, the printing plate materials are sorted to contain only those materials that contain an SBS binder.

In another embodiment, the photopolymer printing plate materials include printing plates processed from liquid photoresins based on ethylenically unsaturated prepolymers, including, for example, unsaturated polyester resins, unsaturated polyurethane resins, unsaturated polyamide resins and unsaturated poly (meth) acrylate resins, such as, for example polyether urethane polymers, or polyether polyester urethane copolymers such as polyether polyester urethane methacrylate photopolymers. Thus, the printing plate materials may also be separated to include only those materials that contain a particular ethylenically unsaturated prepolymer.

Alternatively, the sorting step may be based on the type of printing plate (i.e., liquid or sheet polymer), thick plates versus thin plates Shore A hardness, etc. In one embodiment, the photopolymer printing plate materials may be sorted to separate plates having a Shore A hardness of less than about 40 from those plates having a Shore A hardness of greater than about 40. Generally, plates having a lower Shore A hardness (i.e., less than about 40 or less than about 35 or less than about 30) will have greater tackiness.

Alternatively, the photopolymer printing plates may be sorted to separate plates having a gauge of less than about 0.107 inches from plates having a gauge of greater than about 0.107 inches. Other sorting means would also be known to those skilled in the art. However, sorting the photopolymer printing plate materials based on the type of binder is a preferred sorting method.

Typical backing and/or support layers comprise thermoplastic materials including polyesters, such as polyethylene terephthalate (PET) or polyethylene naphthalate (PEN), and these materials are suitable for being recycled along with the photocurable or photocured layers of the photopolymer printing plate materials. Therefore, these backing and/or support layers do not need to be removed prior to recycling the photopolymer printing plate materials. In addition, carbon black layers and remnants thereof also do not need to be removed from the photopolymer printing plate materials and also do not need to be removed prior to recycling the photopolymer printing plate materials. Likewise, ink residues remaining on a surface of used printing plates do not need to be removed prior to recycling the used flexographic printing plates. However, certain layers that may be contained in the photopolymer printing plate materials may be deemed to not be suitable for being recycled and/or may produce a granulated product that would not have desired properties that would be suitable for use in certain products and these certain layers can and should be removed prior to the grinding step.

Once the materials are identified and/or sorted, those sorted materials are subjected to a grinding step. This grinding step may be a single or multi-step process and the grinding step or steps may be performed cryogenically or non-cryogenically.

The grinding step is an important step in the process of the instant invention as it provides a reproducible and consistent granulated product. However, it has been discovered that the grinding step can be impacted by the tackiness of the printing plate materials being processed. For example, as described above, while printing plates manufactured from sheet polymers can generally be processed/recycled in an efficient manner due to their general lack of tackiness, printing plates manufactured from liquid photopolymers and/or certain liquid-processed sheet polymers can be more difficult to process due to their higher level of tackiness. In addition, water-washed sheet polymers may also have a higher level of tack, and can also be hard to process. Other examples of plates that have a higher level of tack include softer photopolymer plates, such as those used in corrugated print applications and compressible printing plates, which may include one or more of a compressible backing layer or a compressible printing layer. This greater level of tackiness makes it more difficult to produce a granulated product and the resulting granulated produce is less uniform in size and has a greater tendency to clump. Thus, it is desirable that the level of tackiness be reduced prior to the grinding step.

In one embodiment, the photopolymer printing plate materials are subjected to an initial shredding step in which the photopolymer printing plate materials are shredded, cut or chipped to reduce the photopolymer printing plate materials to smaller chips or shreds of a generally uniform size, which may be, for example between about 0.1 and about 10 cm, or between about 0.5 and about 8 cm, or between about 1 and about 5 cm. These chips or shreds can then be subjected to a granulation process to produce particles or granules having the desired particle size.

In one embodiment, prior to the granulation process and after the initial shredding step, the chips or shreds are subjected to an exposure step to reduce tack and increase the brittleness of the material. In one embodiment, this exposure step is accomplished by exposing the chips or shreds to UV-C light at a wavelength in the range of 200 to 280 nm for a period of between about 1 and about 45 minutes or between about 2 and about 40 minutes or between about 5 and about 30 minutes. While various UV-C light sources are available, in one embodiment, the UV-C light source comprises one or more quartz lamps.

While this exposure step maybe accomplished as either a batch process or a continuous process, in one embodiment, the chips or shreds are spread in a substantially single layer on a conveyor belt and the conveyor belt is moved relative to the UV-C light source at a speed that provides sufficient time for the chips or shreds to become less tacky and increase in brittleness. In one embodiment, the UV-C light source is positioned at a height of 2 to 20 cm from the surface of the conveyor belt. The UV-C light source is arranged across the width of the conveyor belt to simultaneous treat the width of material on the conveyor belt. The speed of the conveyor belt is generally in the range of about 0.1 to about 5 feet/minute. However, other speeds are contemplated so long as they provide sufficient exposure time to the UV-C light source.

The UV-C light source may include a light bar comprising one or more quartz lamps arranged across the width of the conveyor belt. Alternatively, the UV-C light source comprises an array of UV-C light sources arranged in a staggered fashion over the width of the conveyor belt. Other arrangements of the UV-C light sources would also be known to those skilled in the art. What is important is that the UV-C light source or sources are arranged to expose the chips or shreds to UV-light for a sufficient time to reduce tack and increase brittleness.

In one embodiment, brittleness of the chips or shreds or other printing plates materials may be determined by observing the surface of the materials. That is, there is sufficient increased brittleness in the chips or shreds or other printing plate materials when surface cracking is observed on the surface. In one embodiment, the chips or shreds or other printing plate materials are exposed to the UV-C light source until more than cracking is observed on more than 40% of the surface, or more than 50% of the surface or more than 60% of the surface or more than 70% of the surface or more than 80% of the surface. In another embodiment, sufficient increased brittleness can be observed by the appearance of haze upon bending of the plate material. In still another embodiments, sufficient brittleness is achieved when the shreds or chips or other printing plate materials snap or break easily when pressure is applied.

As discussed above, the grinding step may comprise one or more of cryogenic grinding and non-cryogenic grinding, which steps may be used alone or in combination.

In non-cryogenic grinding, once the initial shredding step has been performed, a finishing mill grinds the material to the desired particle size. This step may be performed one or more times until the desired particle size has been achieved. After each processing step, the material may classified by sifting screens or other similar means that return oversize pieces to the granulator or mill for further processing. Magnets may be used to remove metal contaminants if necessary.

Cryogenic processing uses liquid nitrogen or other materials/methods to freeze the used shreds or chips prior to size reduction. Most photocurable or photocured materials described herein become embrittled or “glass-like” at temperatures below about −80° C. The use of cryogenic temperatures can be applied at any stage of size reduction. The material can be cooled in a tunnel style chamber, immersed in a “bath” of liquid nitrogen, or sprayed with liquid nitrogen to reduce the temperature of the granulated product. The cooled particles can be size-reduced in an impact type reduction unit, centrifuge, or hammer mill. The process reduces the photopolymer printing plate materials to a granulated product. Cryogenic grinding avoids heat degradation of the photopolymer printing plate materials and produces a high yield of the granulated product.

A wet grinding process can also be used to produce the granulated product. The wet grind process mixes the chips or shreds of the photopolymer printing plate materials with water creating a slurry. This slurry is then conveyed through size reduction and classification equipment. When the desired size is achieved, the slurry is conveyed to equipment for removing the majority of the water and then drying. Aside from the use of water, the same basic principles that are used in an ambient process are utilized in a wet grinding process.

All of these processes can be used to grind the photopolymer printing plate materials and produce the granulated product. However, the inventors of the present invention have found that it is preferred that the grinding step includes cryogenic grinding, although other grinding steps may be included in addition to the cryogenic grinding step to further refine the end-use product.

As described herein, the granulated product is subjected to a sizing or screening step to remove particles above a certain size. This sizing or screening step may be formed as part of the grinding step or may be a separate step performed after the grinding step. In one embodiment, the polyethylene terephthalate (PET) backing layer is part of the larger screened material and generally comprises larger size PET flakes that are typically sized between above 2 mm or about 3 mm or between 3 mm and about 10 mm with a tendency towards the larger size particles. This material can be used in any of the many applications where recycled PET flakes are used such as food packaging, non-food packaging, automotive parts, technical and textile fibers such as clothing, carpets and bedding.

The sized granulated product generally has a desired particle size within the range of less than about 10 mm, more preferably less than about 10 mm, even more preferably less than about 5 mm, or even less than about 3 mm. In one embodiment, the particles are screened to remove particles having a diameter of greater than about 5 mm, more preferably greater than about 3 mm. In one embodiment, more than 80% or more than 90% or more than 95% of the particles have a diameter within the range of about 6 to about 9.5 mm.

In one embodiment, the sizing and/or screening step may comprises a first step in which the granulated product is screened to remove the larger flakes or particles which generally constitute polyethylene terephthalate (PET) from cover films and backing layers, followed by a second step to screen out additional larger particles (i.e., particles larger than 10 mm, preferably particles larger than 5 mm size) which may either be fed back into the process for reduction in size or sized and removed for further use.

Alternatively, a first screening step may be performed to screen out large size particles (i.e., particles greater than 10 mm or greater than 15 mm or greater than 20 mm, which particles may be fed back into the process for reduction in size or removed for further use. Thereafter, the particles may be screened to remove PET flakes having a diameter of greater than about 3 mm or greater than about 6 mm or between 3 mm and 10 mm in size.

Once the granulated product has been screened, an anti-tack agent can be added to the screened and granulated particles to prevent clumping. For example, the anti-tack agent may be selected from the group consisting of fumed silica, fillers such as talc, mica, clay, and carbonate, metallic stearates such as zinc stearate, magnesium stearate, and calcium stearate, potassium stearate, stearic acid, liquid lubricants, emulsified wax, and calcium silicate, among others. In one embodiment, the anti-tack agent comprises fumed silica.

The granulated product(s) can be used to replace post-consumer recycled material (PCRM), in whole or in part in various building materials and other sustainable products. Thus, in one embodiment, the used flexographic printing elements and/or unused photocurable printing blank materials can be used to produce a granulated product to replace PCRM in sustainable building materials such as asphalt shingles.

In one embodiment, the sustainable building material is a roofing tile or roofing shingle and the ground material is used in combination with other materials to produce a roofing tile or roofing shingle incorporating a large concentration of granulated recycled material. Other materials include, but are not limited to, asphalt, paving materials, and synthetic building materials, including synthetic lumber. For example, the sustainable building materials may be a fiber cement product composed of cement, sand and cellulose fibers (a commercial product of which is available under the brand name Hardie®) including boards, siding or trim. The granulated product may replace at least a portion of the cement, sand and/or cellulose fibers. The same is true of other engineered products, including engineered wood products in which the granulated product can be used to reduce some or all of the filler or other material contained in the engineered product. Other products include, but are not limited to, flotation on docking systems, after-market repair products and concrete forms.

Vehicle construction materials also contain various filler materials that can be replaced in whole or in part by the granulated product described herein, including, for example, vehicle construction materials such as door jamb casings, interior trim, and train and truck flooring dividers, among others.

Other engineered products that may be constructed using the granulated products describe herein include, for example, pallets, cabinetry, crating for freight, temporary structures, sheds, trusses, laminated beam replacement, sub-flooring, exterior sheeting for walls, exterior sheeting for roofs, laminate flooring, drywall replacement, interior doors, exterior doors, coolers, industrial shelves, sub surface, exterior underlayment, knock down furniture, pre-formed steps, bathtubs, sink tops, swimming pools, acoustical ceiling tiles, Formica countertops (wood replacement), exterior furniture, interior furniture, form boards, manufactured homes, structural construction, framing materials, sound deadening panels, and window casings, among others.

The granulated products described herein may also be used in marine applications, such as marine pilings (both round and square), marine decking, marine decking frame systems, mezzanine decking, boat decking, boat stringers and interior furniture, deck boards, and pier houses, and other similar materials which may be constructed with filler materials, at least a portion of which may be replaced in whole or in part by the granulated product described herein.

Another area in which the granulated products described herein may be used is printing applications, such as cutting dies for the folding carton and corrugated markets (flat), cutting dies for the corrugated market (in the round), printing foam for the corrugated market, and printing tapes for flexographic printing (non-corrugated) market.

Additional applications, include, but are not limited to military bullet proof, lightweight, temporary structures, signage, returnable containers, point of purchase containers for fruit and vegetable that may be returned for reuse, as a replacement for slate on pool and billiards tables, aircraft interiors, circuit boards and other non-conductive electronic substrates, electronics housings, and insulated concrete forms (ICF).

### EXAMPLE 1

Photopolymer printing plate materials were evaluated and sorted to remove any photopolymer printing plate materials not utilizing a styrene-butadiene-styrene binder to leave only photopolymer printing plate materials based on styrene-butadiene-styrene photopolymers and comprising a polyethylene terephthalate (PET) backing layer. These photopolymer printing plate materials were ground to produce a granulated product using cryogenic grinding. The granulated product was then screened to remove particles larger than 10 mm in size. The remaining product which comprised larger sized polyethylene terephthalate flakes (including flakes size between about 1400 microns and about 0.125 inches, was further processed for additional uses.

### EXAMPLE 2

Photopolymer printing plate materials were evaluated and sorted to remove any photopolymer printing plate materials not utilizing a styrene-butadiene-styrene binder to leave only photopolymer printing plate materials based on styrene-butadiene-styrene photopolymers and comprising a polyethylene terephthalate (PET) backing layer.

Prior to a grinding step, the photopolymer printing plate materials were first subjected to an initial shredding step to reduce the photopolymer printing plate materials to smaller shreds. Next, the photopolymer printing plate shreds were exposed to a UV-C light source for a sufficient time to reduce tackiness and make the photopolymer printing plate shreds more brittle.

Thereafter, the shredded and UV-C light treated photopolymer printing plate materials were ground to produce a granulated product using cryogenic grinding. The granulated product was then screened to remove particles larger than 10 mm in size. The remaining product which comprised larger sized polyethylene terephthalate flakes (including flakes size between about 1400 microns and about 0.125 inches, was further processed for additional uses.

### EXAMPLE 3

The granulated product of Example 1 was evaluated to test the compatibility of the product with other post-consumer recycled materials (PCRM) and polymers.

A complex formulation was selected that normally consists of 5% PCRM+3% polymer+3% polymer to 3% PCRM. 2.5% of the 5% PCRM was replaced with 2.5% of the granulated product of Example 1. The blend results revealed that the granulated product was compatible with other PCRM and other types of polymer. It was also observed that the testing results were slightly better than the control results.

### EXAMPLE 4

For the next blend, the 5% PCRM was totally replaced with 5% of the granulated product of Example 1. This material was blended filled and unfilled. These test results were also better than the control results.

The examples demonstrated that the granulated product described herein is a viable product to replace at least a portion of PCRM in asphalt compositions. It is also contemplated that the granulated product described herein can be used to replace at least a portion of PCRM in building materials and other products that contain a portion of PCRM.

Finally, it should also be understood that the following claims are intended to cover all of the generic and specific features of the invention described herein and all statements of the scope of the invention that, as a matter of language might fall therebetween.

### Additional Embodiments

Clause 1: A method of producing a granulated product from photopolymer printing plate materials, the method comprising the steps of:
sorting the photopolymer printing plate materials based on an identifiable property;
optionally, shredding or chipping the photopolymer printing plate materials to reduce the size of the photopolymer printing plate materials to smaller chips or shreds having a relatively uniform size;
subjecting the photopolymer printing plate materials to UV-C light from a UV-C light source for a period of time, whereby the photopolymer printing plate materials are rendered less tacky and more brittle;
grinding the photopolymer printing plate materials to particles; and
screening the particles to remove particles above a certain size to produce the granulated product.

Clause 2: The method according to Clause 1, wherein photopolymer printing plate materials comprise used photocured or photopolymerized flexographic printing elements comprising one or more cured photopolymer layers on a support layer.

Clause 3: The method of Clause 1 or Clause 2, wherein the step of shredding or chipping is performed.

Clause 4: The method of any of Clauses 1 to 3, wherein the steps are performed in order.

Clause 5: The method of any of Clauses 1 to 4, wherein the steps of grinding and screening are repeated at least once.

Clause 6: The method according to any of Clauses 1 to 5, wherein the screened particles above the certain size comprise polyethylene terephthalate, wherein the polyethylene terephthalate is in the form of flakes or particles having a size between about 1400 microns and about 0.125 inches.

Clause 7: The method according to Clause 2, wherein the one or more cured photopolymer layers comprise a binder selected from styrene-isoprene-styrene and styrene-butadiene-styrene.

Clause 8: The method according to Clause 3, wherein the binder comprises styrene-butadiene-styrene.

Clause 9: The method according to Clause 2, wherein the one or more cured photopolymer layers are processed from liquid photoresins based on ethylenically unsaturated prepolymers selected from the group consisting of unsaturated polyester resins, unsaturated polyurethane resins, unsaturated polyamide resins, and unsaturated poly (meth) acrylate resins.

Clause 10: The method according to Clause 9, wherein the photoresin comprises an unsaturated polyurethane resin.

Clause 11: The method according to Clause 2, wherein the support layer is not removed from the one or more photopolymer layers prior to the grinding step.

Clause 12: The method according to any of Clauses 1 to 11, wherein the identifiable property is selected from the group consisting of type of binder, Shore A hardness of the photopolymer, printing plate gauge, and combinations of one or more of the foregoing.

Clause 13: The method according to any of Clauses 1 to 12, wherein the granulated product has a particle size of less than 20 mm.

Clause 14: The method according to Clause 13, wherein the granulated product has a particle size of less than 10 mm, preferably less than 5 mm.

Clause 15; The method according to any of Clauses 1 to 14, wherein an anti-tack agent is added to the granulated product after step c).

Clause 16: The method according to Clause 15 wherein the anti-tack agent is selected from the group consisting of fumed silica, talc, mica, clay, carbonate, zinc stearate, magnesium stearate, calcium stearate, potassium stearate, stearic acid, liquid lubricants, emulsified wax, and calcium silicate.

What is claimed is:

1. A method of producing a granulated product from photopolymer printing plate materials, the method comprising the steps of:
a) sorting the photopolymer printing plate materials based on an identifiable property;
b) optionally, shredding or chipping the photopolymer printing plate materials to reduce the size of the photopolymer printing plate materials to smaller chips or shreds having a relatively uniform size;
c) subjecting the photopolymer printing plate materials to UV-C light from a UV-C light source for a period of time, whereby the photopolymer printing plate materials are rendered less tacky and more brittle;
d) grinding the photopolymer printing plate materials to particles; and
e) screening the particles to remove particles above a certain size to produce the granulated product.

2. The method according to claim 1, wherein photopolymer printing plate materials comprise used photocured or photopolymerized flexographic printing elements comprising one or more cured photopolymer layers on a support layer.

3. The method of claim 1, wherein the step of shredding or chipping is performed.

4. The method of claim 1, wherein the steps are performed in order.

5. The method of claim 1, wherein the steps of grinding and screening are repeated at least once.

6. The method according to claim 1, wherein the screened particles above the certain size comprise polyethylene terephthalate, wherein the polyethylene terephthalate is in the form of flakes or particles having a size between about 3 mm and about 10 mm.

7. The method according to claim 2, wherein the one or more cured photopolymer layers comprise a binder selected from styrene-isoprene-styrene and styrene-butadiene-styrene.

8. The method according to claim 3, wherein the binder comprises styrene-butadiene-styrene.

9. The method according to claim 2, wherein the one or more cured photopolymer layers are processed from liquid photoresins based on ethylenically unsaturated prepolymers selected from the group consisting of unsaturated polyester resins, unsaturated polyurethane resins, unsaturated polyamide resins, and unsaturated poly (meth) acrylate resins.

10. The method according to claim 9, wherein the photoresin comprises an unsaturated polyurethane resin.

11. The method according to claim 2, wherein the support layer is not removed from the one or more photopolymer layers prior to the grinding step.

12. The method according to claim 1, wherein the identifiable property is selected from the group consisting of type of binder, Shore A hardness of the photopolymer, printing plate gauge, and combinations of one or more of the foregoing.

13. The method according to claim 1, wherein the granulated product has a particle size of less than 20 mm.

14. The method according to claim 13, wherein the granulated product has a particle size of less than 10 mm.

15. The method according to claim 14, wherein the granulated product has a particle size of less than 5 mm.

16. The method according to claim 1, wherein an anti-tack agent is added to the granulated product after step c).

17. The method according to claim 16, wherein the anti-tack agent is selected from the group consisting of fumed silica, talc, mica, clay, carbonate, zinc stearate, magnesium stearate, calcium stearate, potassium stearate, stearic acid, liquid lubricants, emulsified wax, and calcium silicate.
